(19) United States
(12) Patent Application Publication
(10) Pub. No.: US 2015/0063531 A1
(43) Pub. Date: Mar. 5, 2015

(54) COLLIMATOR-DETECTOR STRUCTURE FOR A CT IMAGING SYSTEM

(71) Applicant: General Electric Company, Schenectady, NY (US)

(72) Inventor: Abdelaziz Ikhlef, Hartland, WI (US)

(73) Assignee: General Electric Company, Schenectady, NY (US)

(21) Appl. No.: 14/011,897

(22) Filed: Aug. 28, 2013

(51) Int. Cl. G01T 1/20; G01N 23/04

(52) U.S. Cl. CPC G01T 1/20; G01N 23/046
USPC 378/19

(57) ABSTRACT

A detector assembly for a CT imaging system includes a scintillator array comprising a plurality of scintillator cells, and configured to detect high frequency electromagnetic energy attenuated through an object, the scintillator array including a reflective material positioned around each of the plurality of scintillator cells to form reflector channels between each of the plurality of scintillator cells. The CT imaging system also includes a collimator positioned proximate the scintillator array and configured to filter the high frequency electromagnetic energy attenuated through the object prior to impinging on the scintillator array, the collimator comprising a plurality of collimator plates arranged to form a plurality of channels. The reflector channels in the scintillator array are formed to have a first thickness and the collimator plates of the collimator are formed to have a second thickness that is equal to or less than the first thickness.

### BACKGROUND OF THE INVENTION

Embodiments of the invention relate generally to collimators for use in diagnostic imaging and, more particularly, to a collimator construction and arrangement that provides increased alignment tolerance between the collimator and a scintillator array and reduces spectral and thermal non-linearity issues related to the interaction of the collimator and the scintillator array.

Typically, in computed tomography (CT) imaging systems, an x-ray source emits a fan-shaped beam toward a subject or object, such as a patient or a piece of luggage. Hereinafter, the terms “subject” and “object” shall include anything capable of being imaged. The beam, after being attenuated by the subject, impinges upon an array of radiation detectors. The intensity of the attenuated beam radiation received at the detector array is typically dependent upon the attenuation of the x-ray beam by the subject. Each detector element of the detector array produces a separate electrical signal indicative of the attenuated beam received by each detector element. The electrical signals are transmitted to a data processing system for analysis which ultimately produces an image.

Generally, the x-ray source and the detector array are rotated about the gantry within an imaging plane and around the subject. X-ray sources typically include x-ray tubes, which emit the x-ray beam at a focal point. X-ray detectors typically include a collimator, currently made of highly absorbing material such as tungsten or lead, for collimating x-ray beams received at the detector, a scintillator for converting x-rays to light energy adjacent the collimator, and photodiodes for receiving the light energy from the adjacent scintillator and producing electrical signals therefrom. The outputs of the photodiodes are then transmitted to the data processing system for image reconstruction.

As stated above, typical x-ray detectors include a collimator for collimating x-ray beams such that collection of scattered x-rays is minimized. As such, the collimators operate to attenuate off-angle scattered x-rays from being detected by a scintillator cell. Reducing this scattering reduces noise in the signal and improves the final reconstructed image. Therefore, it is necessary that the scintillator array and the collimator—which is formed of plates extending along one or two dimensions above the scintillator array—is uniformly aligned at scintillator cell boundaries defined by a cast reflector material and have a plate in every channel between each scintillator cell. That is, currently exact mechanical alignment is required between the collimator plates and the cast reflector channels in the array of scintillators.

Known manufacturing processes attempt this exact alignment by constructing a continuous collimator that is sized to dimensionally match the width and length of the entire detector array. That is, the collimator plates are arranged or arrayed in a continuous consistent pattern or pitch that spans the entire detector length and is placed and attached to the detector rail structure. As such, individual scintillator arrays or packs must then be exactly aligned to the continuous collimator to ensure that all scintillator cells and collimator cells are aligned exactly. This process requires tight tolerancing and requires great operator skill and patience to assemble.

A known CT detector 1 fabricated according to known manufacturing processes is shown in FIG. 1. The CT detector 1 includes a series of tungsten collimator plates 2 configured and positioned to collimate x-rays projected toward scintillator cells 3 of a scintillator array 4. As shown, each of the collimator plates 2 is generally aligned with a reflector channel 5 disposed between adjacent scintillator cells 3 that prevents light from being emitted between adjacent scintillators—with an air gap 6 being present between the collimator plates 2 and the scintillator cells 3 due to the manufacturing process whereupon the collimator plates 2 are formed as a single collimator assembly that accepts and aligns an array of scintillators 4. The scintillator array 4 is coupled to a photodiode array 7 that detects light emissions from the scintillator array and transmits corresponding electrical signals to a data acquisition system for signal processing.

As shown in FIG. 1, the collimator plates 2 are generally constructed such that they are wider than a width of the reflector channels 5. This increased thickness of the collimator plates 2 relative to the reflector channels 5 further aggravates the already tight tolerancing required between the collimator plates 2 and the scintillator cells 3, as any misalignment of the collimator plates 2 with the scintillator cells 3 will result in the collimator plates 2 covering a substantial portion of scintillator cells 3, such that performance of the detector can be compromised. In addition, the increased thickness of the collimator plates 2 and the alignment thereof with the reflector channels 5 increases spectral non-linearity due to the interaction of the plates 2 and the scintillator cell edges (which occurs especially during calibration) and increases thermal non-linearity due to the interaction of plate shadows with scintillator cell edges (and the thermal expansion caused thereby).

Therefore, it would be desirable to design a detector assembly and method of manufacturing thereof that provides for easy alignment between the scintillator array and collimator assembly having relaxed alignment tolerances therebetween, that effectively reduces spectral and thermal non-linearities, and that reduces manufacturing and testing costs for CT detectors.

### BRIEF DESCRIPTION OF THE INVENTION

In accordance with one aspect of the invention, a detector assembly for a CT imaging system includes a scintillator array comprising a plurality of scintillator cells, and configured to detect high frequency electromagnetic energy attenuated through an object, the scintillator array including a reflective material positioned around each of the plurality of scintillator cells to form reflector channels between each of the plurality of scintillator cells. The detector assembly also includes a collimator positioned proximate the scintillator array and configured to filter the high frequency electromagnetic energy attenuated through the object prior to impinging on the scintillator array, the collimator comprising a plurality of collimator plates arranged to form a plurality of channels. The reflector channels in the scintillator array are formed to have a first thickness and the collimator plates of the collimator are formed to have a second thickness that is equal to or less than the first thickness.

In accordance with another aspect of the invention, a CT imaging system includes a rotatable gantry having an opening to receive an object to be scanned, a high frequency electromagnetic energy projection source configured to project a high frequency electromagnetic energy beam toward the object, and a detector assembly positioned on the gantry opposite the high frequency electromagnetic energy projection source. The detector assembly further includes a scintillator array comprising a plurality of scintillator cells, and configured to detect high frequency electromagnetic energy attenuated through an object, wherein a reflective material is positioned around each of the plurality of scintillator cells to form reflector channels between each of the plurality of scintillator cells. The detector assembly still further includes a collimator positioned proximate the scintillator array and configured to filter the high frequency electromagnetic energy attenuated through the object prior to impinging on the scintillator array, the collimator comprising a plurality of collimator plates arranged to form a plurality of channels. The reflector channels in the scintillator array are formed to have a first thickness and the collimator plates of the collimator are formed to have a second thickness that is equal to or less than the first thickness.

In accordance with yet another aspect of the invention, a detector assembly for a CT imaging system includes a scintillator array comprising a plurality of scintillator cells and configured to detect high frequency electromagnetic energy attenuated through an object, the scintillator array including a reflective material positioned around each of the plurality of scintillator cells to form reflector channels between each of the plurality of scintillator cells. The detector assembly also includes a collimator positioned proximate the scintillator array and configured to filter the high frequency electromagnetic energy attenuated through the object prior to impinging on the scintillator array, the collimator comprising a plurality of collimator plates arranged to form a plurality of channels, and wherein each of the plurality of collimator plates is aligned with a centerline of a respective scintillator cell.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a cross-sectional view of a prior art CT detector having a collimator aligned with a scintillator array.

FIG. 2 is a pictorial view of a CT imaging system.

FIG. 3 is a block schematic diagram of the system illustrated in FIG. 2.

FIG. 4 is a perspective view of one embodiment of a CT system detector array.

FIG. 5 is perspective view of a collimator according to an embodiment of the invention.

FIG. 6 is a perspective view of one embodiment of a detector.

FIG. 7 is a cross-sectional view of a CT detector having a collimator aligned with a scintillator array according to an embodiment of the invention.

FIG. 8 is a cross-sectional view of a CT detector having a collimator aligned with a scintillator array according to an embodiment of the invention.

FIG. 9 is a pictorial view of a CT system for use with a non-invasive package inspection system.

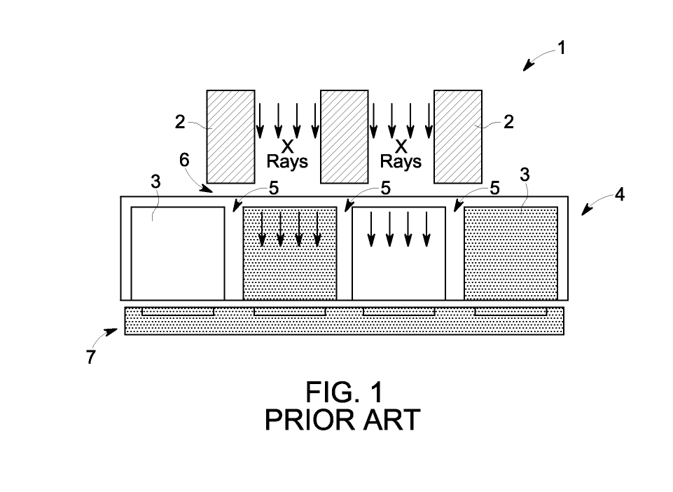

### DETAILED DESCRIPTION

The operating environment of the invention is described with respect to a sixty-four-slice computed tomography (CT) system. However, it will be appreciated by those skilled in the art that the invention is equally applicable for use with other multi-slice configurations. Moreover, the invention will be described with respect to the detection and conversion of x-rays. However, one skilled in the art will further appreciate that the invention is equally applicable for the detection and conversion of other high frequency electromagnetic energy. The invention will be described with respect to a “third generation” CT scanner, but is equally applicable with other CT systems.

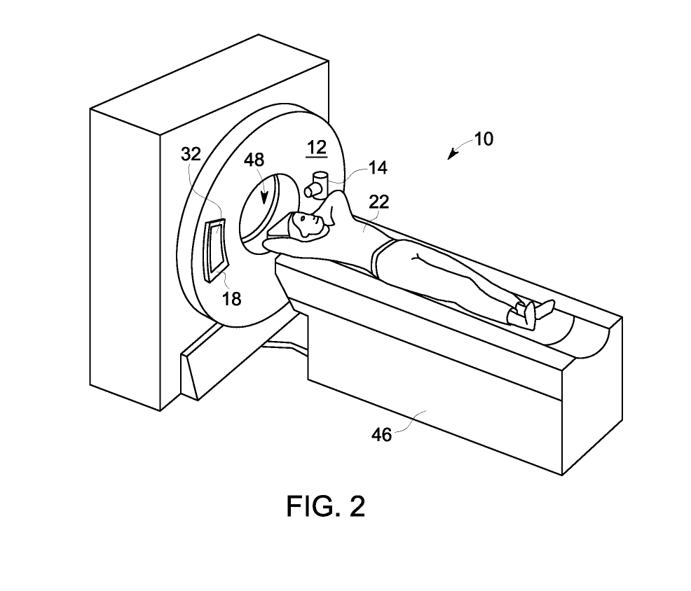

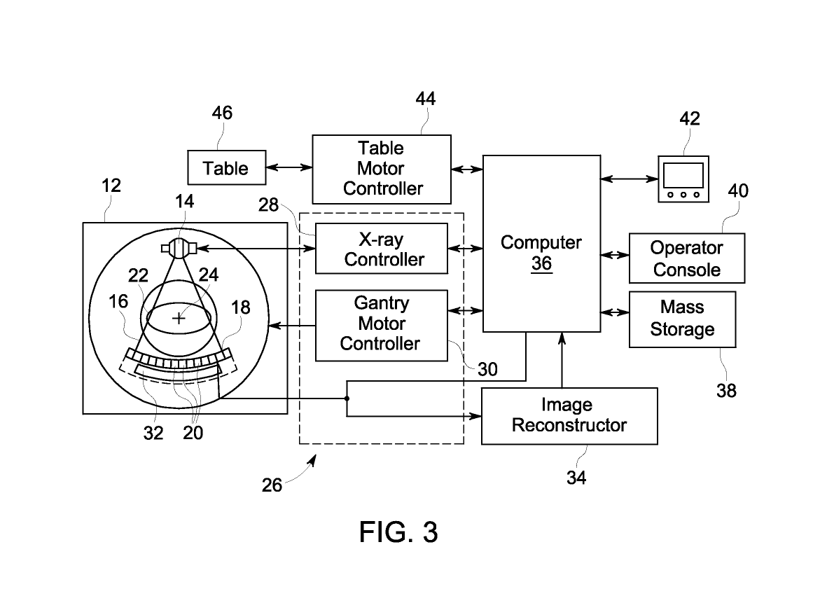

Referring to FIG. 2, a computed tomography (CT) imaging system 10 is shown as including a gantry 12 representative of a “third generation” CT scanner. Gantry 12 has an x-ray source 14 that projects a beam of x-rays toward a detector assembly 18 on the opposite side of the gantry 12. Referring now to FIG. 3, detector assembly 18 is formed in part by a plurality of detectors 20 and data acquisition systems (DAS) 32. The plurality of detectors 20 sense the projected x-rays 16 that pass through a medical patient 22, and DAS 32 converts the data to digital signals for subsequent processing. Each detector 20 produces an analog electrical signal that represents the intensity of an impinging x-ray beam and hence the attenuated beam as it passes through the patient 22. During a scan to acquire x-ray projection data, gantry 12 and the components mounted thereon rotate about a center of rotation 24.

Rotation of gantry 12 and the operation of x-ray source 14 are governed by a control mechanism 26 of CT system 10. Control mechanism 26 includes an x-ray controller 28 that provides power and timing signals to an x-ray source 14 and a gantry motor controller 30 that controls the rotational speed and position of gantry 12. An image reconstructor 34 receives sampled and digitized x-ray data from DAS 32 and performs high speed reconstruction. The reconstructed image is applied as an input to a computer 36 which stores the image in a mass storage device 38.

Computer 36 also receives commands and scanning parameters from an operator via console 40 that has some form of operator interface, such as a keyboard, mouse, voice activated controller, or any other suitable input apparatus. An associated display 42 allows the operator to observe the reconstructed image and other data from computer 36. The operator supplied commands and parameters are used by computer 36 to provide control signals and information to DAS 32, x-ray controller 28 and gantry motor controller 30. In addition, computer 36 operates a table motor controller 44 which controls a motorized table 46 to position patient 22 and gantry 12. Particularly, table 46 moves patients 22 through a gantry opening 48 of FIG. 2 in whole or in part.

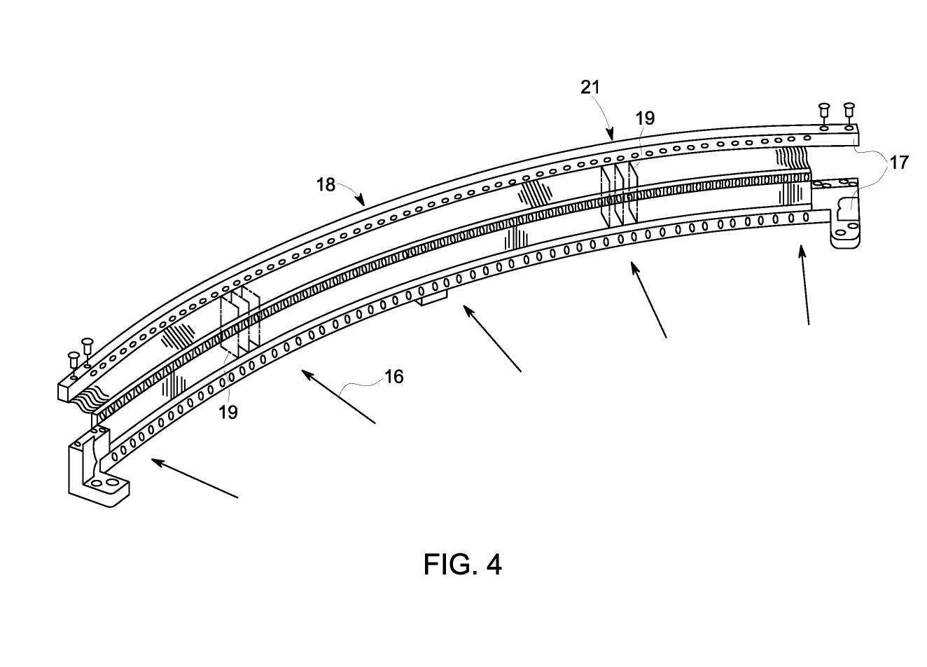

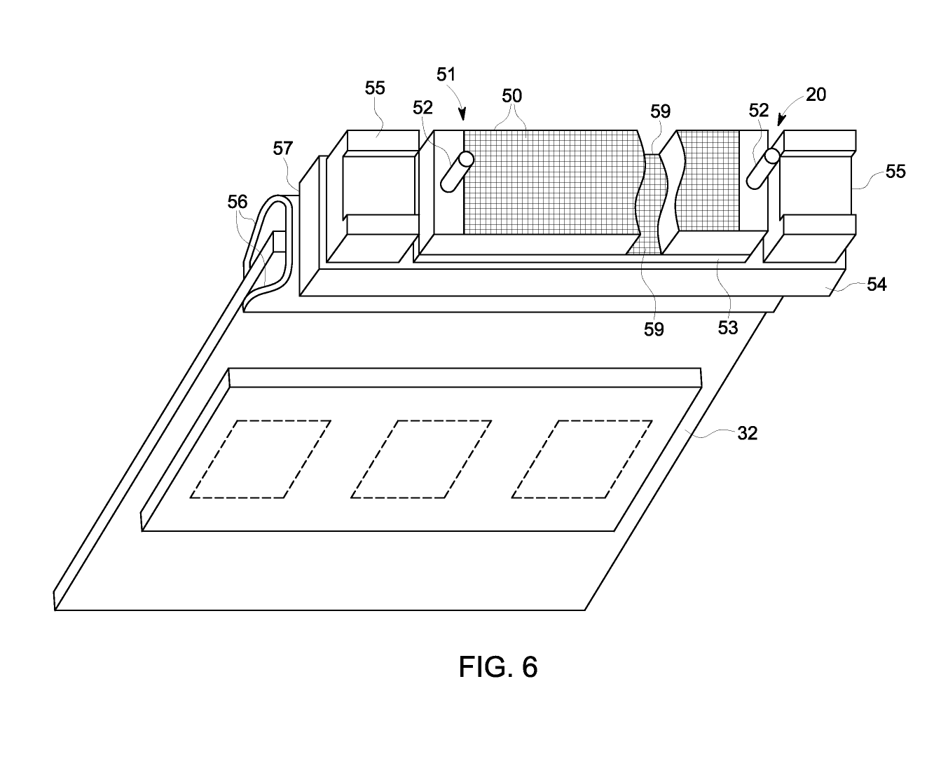

As shown in FIG. 4, detector assembly 18 further includes rails 17 having collimating blades or plates 19 placed therebetween that collectively form a collimator 21, with the collimator plates 19 being generally made of tungsten, molybdenum, or lead. Collimator plates 19 are positioned to collimate x-rays 16 before such beams impinge upon, for instance, detector 20 of FIG. 6 positioned on detector assembly 18. In one embodiment, detector assembly 18 includes 57 detectors 20, each detector 20 having an array size of 64×16 of scintillator cells 50 (i.e., pixel elements). As a result, detector assembly 18 has 64 rows and 912 columns (16×57 detectors) which allows 64 simultaneous slices of data to be collected with each rotation of gantry 12.

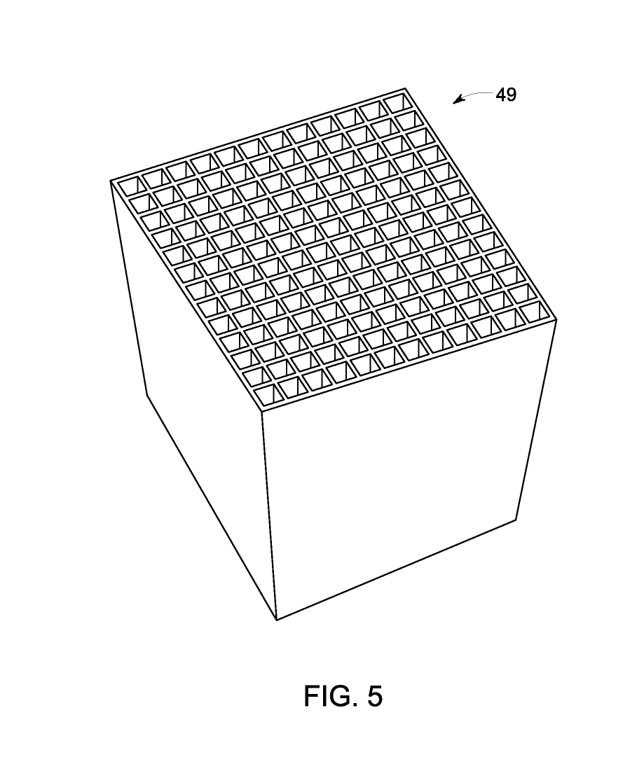

While collimator 21 is shown in FIG. 4 as including collimator plates 19 being formed as linear blades extending in a single direction/dimension, it is recognized that the collimator could instead be constructed as a “two dimensional collimator” 49 such as shown in FIG. 5, with a blade/wall structure that forms a honeycomb structure defining a two dimensional array of channels that collimate x-rays attenuated by the subject 22, for example, prior to the x-rays impinging upon detector 20 (FIG. 6).

A detector 20 is shown in FIG. 6 for use with embodiments of the invention. Each detector 20 includes a number of detector elements 50 (i.e., scintillator cells or pixels) forming an array or pack 51 (i.e., scintillator array). Scintillator array 51 is optically coupled to a photodiode array 53 having a plurality of diodes 59, with backlit diode array 53 in turn being positioned on, and electrically coupled to, multi-layer substrate 54. As further shown in FIG. 6, detectors 20 also include pins 52 positioned relative to scintillator array 51 and spacers 55 positioned on multi-layer substrate 54. Flex circuits 56 are attached to face 57 of multi-layer substrate 54 and to DAS 32. Detectors 20 are positioned within detector assembly 18 by use of pins 52. In the operation of one embodiment, x-rays impinging within detector elements 50 generate photons which traverse scintillator array 51, thereby generating an analog signal which is detected on a diode within backlit diode array 53. The analog signal generated is carried through multi-layer substrate 54, through flex circuits 56, to DAS 32 wherein the analog signal is converted to a digital signal.

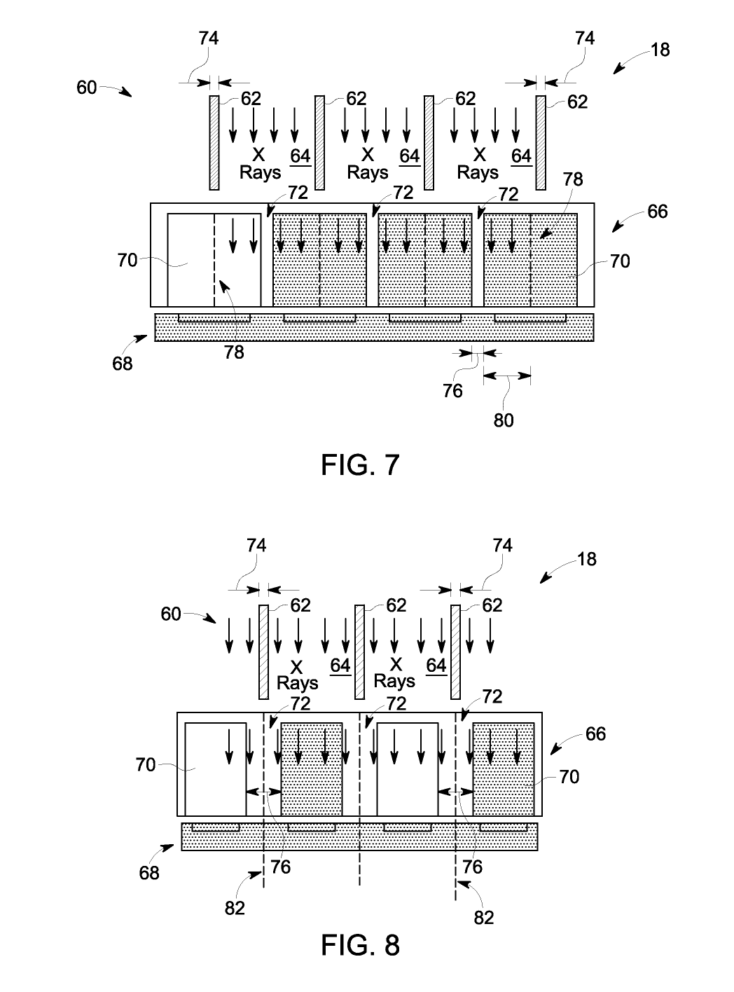

Referring now to FIGS. 7 and 8, a cross-sectional view of a portion of detector assembly 18 are shown according to embodiments of the invention. As shown in FIGS. 7 and 8, detector assembly 18 includes a collimator 60 having a plurality of collimator plates 62 positioned proximate detector 20 that define collimator channels 64. While collimator 60 is shown as having a plurality of plates 62 defining only three channels 64, it is noted that FIG. 7 is for illustrative purposes only and that collimator 60 of detector assembly 18 would be formed to include a plurality of plates 62 that defines a greater number of channels 64 arranged in one dimension or in a two-dimensional array. As shown in FIGS. 7 and 8, the plurality of plates 62 of collimator 60 are positioned proximate to and stacked in a vertical arrangement with a scintillator array 66 of the detector 20, with the scintillator array 66 in turn being coupled to a photodiode array 68. The scintillator array 66 includes a plurality of scintillator cells 70 that are separated from one another by a reflective material that is cast around each of the scintillator cells to form reflector channels 72. The reflector channels 72 separate individual scintillator cells 70 from each other to prevent cross-talk therebetween. That is, as collimated x-rays pass through channels 64 created by collimator plates 62 of collimator 60 and impinge on the scintillator material of scintillator cells 70 housed in scintillator array 66 of detector 20, photons are generated. The reflector channels 72 formed around scintillator cells 68 act to reflect these photons, such that they are trapped within a particular scintillator cell 70, allowing for readout thereof by photodiode array 68 without cross-talk interference from adjacent scintillator cells.

According to embodiments of the invention, and as shown in FIGS. 7 and 8, the plates 62 of collimator 60 are formed so as to have a thickness 74 that is reduced as compared to conventional collimator plates. Specifically, collimator plates 62 are formed so as to have a thickness 74 that is equal to or less than a thickness 76 of the reflector channels 72. As one example, the collimator plates 62 may have a thickness of 100 μm, so as to have a thickness 74 that is less than the thickness 76 of reflector channel 72. By controlling a thickness of the collimator plates 62 to be equal to/less than that of the reflector channels 72, the alignment tolerance of the collimator 60 to the scintillator array 66 can be relaxed, as can the alignment tolerances between adjacent scintillator arrays 66 (i.e., the pack-to-pack spacing) in the detector array 18. The controlling of the thickness of the collimator plates 62 also improves detector performance, as it serves to minimize the impact of any misalignment of the collimator plates 62 with the scintillator cells 70 by reducing the area of the scintillator cells 70 that might be covered by the plates 62.

Referring now to FIG. 7, in one embodiment, the plurality of collimator plates 62 are aligned with (or approximately with) centerlines 78 of scintillator cells 70 along at least one dimension. Alignment of the collimator plates 62 with the centerlines 78 of scintillator cells 70 in this manner allows for a relaxation of the alignment tolerance between the collimator 60 and the scintillator array 66 to a range of one half a pitch (indicated as 80 in FIG. 7) of the scintillator cells 70 without affecting performance of the detector 20. The alignment of the collimator plates 62 with the centerlines 78 of scintillator cells 70 also reduces the spectral non-linearity in the scintillator cells 70, as the interaction of the plates 62 and the edges of scintillator cells 70 (which occurs especially during calibration) is minimized. Still further, the alignment of the collimator plates 62 with the centerlines 78 of scintillator cells 70 reduces the thermal non-linearity in the scintillator cells 70, as the interaction of plate shadows with the edges of scintillator cells 70 (and the thermal expansion caused thereby) is also minimized.

Referring now to FIG. 8, in another embodiment, the plurality of collimator plates 62 are aligned with centerlines 82 of the reflector channels 72 in scintillator array 66. As shown in FIG. 8, the reflector channels 72 in scintillator array 66 are significantly thicker than collimator plates 62 (e.g., 2× to 3× thicker), and thus small misalignments of the collimator plates 62 with the reflector channels 72 has a minor affect on performance of the detector 20. That is, the alignment tolerance between the collimator 60 and the scintillator array 66 can be relaxed, as small misalignments of the collimator plates 62 with the reflector channels 72 will still result in the collimator plates 62 being positioned/aligned with the reflector channels 72—such that the plates 62 do not cover a portion of a scintillator cell 70, thereby reducing the spectral and thermal non-linearity in the scintillator cells 70 in the same manner described above.

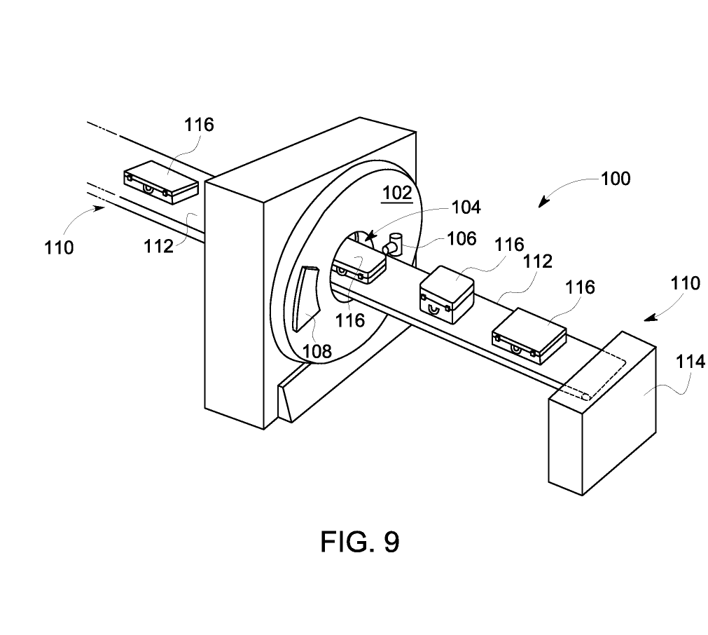

Referring now to FIG. 9, a package/baggage inspection system 100 is shown that can incorporate a detector assembly having a collimator construction and collimator-scintillator alignment as shown and described in FIGS. 7 and 8. The system 100 includes a rotatable gantry 102 having an opening 104 therein through which packages or pieces of baggage may pass. The rotatable gantry 102 houses a high frequency electromagnetic energy source 106 as well as a detector assembly 108 having a collimator construction and collimator-scintillator array arrangement similar to that shown in FIGS. 7 and 8. A conveyor system 110 is also provided and includes a conveyor belt 112 supported by structure 114 to automatically and continuously pass packages or baggage pieces 116 through opening 104 to be scanned. Objects 116 are fed through opening 104 by conveyor belt 112, imaging data is then acquired, and the conveyor belt 112 removes the packages 116 from opening 104 in a controlled and continuous manner. As a result, postal inspectors, baggage handlers, and other security personnel may non-invasively inspect the contents of packages 116 for explosives, knives, guns, contraband, etc.

Beneficially, embodiments of the invention thus provide a detector assembly having a collimator construction that provides for an alignment between the collimator and a scintillator array having relaxed alignment tolerances. The collimator construction/alignment therefore reduces manufacturing and testing/calibration costs for CT detectors. The collimator—and the alignment thereof with the scintillator array—also serves to effectively reduce spectral and thermal non-linearities in the scintillator array.

Therefore, according to one embodiment of the invention, a detector assembly for a CT imaging system includes a scintillator array comprising a plurality of scintillator cells, and configured to detect high frequency electromagnetic energy attenuated through an object, the scintillator array including a reflective material positioned around each of the plurality of scintillator cells to form reflector channels between each of the plurality of scintillator cells. The CT imaging system also includes a collimator positioned proximate the scintillator array and configured to filter the high frequency electromagnetic energy attenuated through the object prior to impinging on the scintillator array, the collimator comprising a plurality of collimator plates arranged to form a plurality of channels. The reflector channels in the scintillator array are formed to have a first thickness and the collimator plates of the collimator are formed to have a second thickness that is equal to or less than the first thickness.

According to another embodiment of the invention, a CT imaging system includes a rotatable gantry having an opening to receive an object to be scanned, a high frequency electromagnetic energy projection source configured to project a high frequency electromagnetic energy beam toward the object, and a detector assembly positioned on the gantry opposite the high frequency electromagnetic energy projection source. The detector assembly further includes a scintillator array comprising a plurality of scintillator cells, and configured to detect high frequency electromagnetic energy attenuated through an object, wherein a reflective material is positioned around each of the plurality of scintillator cells to form reflector channels between each of the plurality of scintillator cells. The detector assembly still further includes a collimator positioned proximate the scintillator array and configured to filter the high frequency electromagnetic energy attenuated through the object prior to impinging on the scintillator array, the collimator comprising a plurality of collimator plates arranged to form a plurality of channels. The reflector channels in the scintillator array are formed to have a first thickness and the collimator plates of the collimator are formed to have a second thickness that is equal to or less than the first thickness.

According to yet another embodiment of the invention, a detector assembly for a CT imaging system includes a scintillator array comprising a plurality of scintillator cells and configured to detect high frequency electromagnetic energy attenuated through an object, the scintillator array including a reflective material positioned around each of the plurality of scintillator cells to form reflector channels between each of the plurality of scintillator cells. The detector assembly also includes a collimator positioned proximate the scintillator array and configured to filter the high frequency electromagnetic energy attenuated through the object prior to impinging on the scintillator array, the collimator comprising a plurality of collimator plates arranged to form a plurality of channels, and wherein each of the plurality of collimator plates is aligned with a centerline of a respective scintillator cell.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A detector assembly for a CT imaging system, the detector assembly comprising:
a scintillator array comprising a plurality of scintillator cells, and configured to detect high frequency electromagnetic energy attenuated through an object, the scintillator array including a reflective material positioned around each of the plurality of scintillator cells to form reflector channels between each of the plurality of scintillator cells;
a collimator positioned proximate the scintillator array and configured to filter the high frequency electromagnetic energy attenuated through the object prior to impinging on the scintillator array, the collimator comprising a plurality of collimator plates arranged to form a plurality of channels;
wherein the reflector channels in the scintillator array are formed to have a first thickness and wherein the collimator plates of the collimator are formed to have a second thickness that is equal to or less than the first thickness.

2. The detector assembly of claim 1 wherein each of the plurality of collimator plates is aligned with a centerline of a respective scintillator cell in at least one dimension.

3. The detector assembly of claim 2 wherein each of the plurality of collimator plates being aligned with the centerline of a respective scintillator cell in at least one dimension increases an alignment tolerance of the collimator plates to the scintillator array.

4. The detector assembly of claim 3 wherein, when each of the plurality of collimator plates is aligned with the centerline of a respective scintillator cell in at least one dimension, the alignment tolerance range of the collimator plates to the scintillator array is equal to one half of a pitch of the scintillator cells.

5. The detector assembly of claim 2 wherein each of the plurality of collimator plates being aligned with the centerline of a respective scintillator cell in at least one dimension eliminates an interaction of a collimator plate shadow with an edge of a respective scintillator cell, so as to reduce spectral non-linearity and thermal non-linearity in the scintillator array.

6. The detector assembly of claim 2 wherein the scintillator array comprises a scintillator pack, and wherein each of the plurality of collimator plates being aligned with the centerline of a respective scintillator cell in at least one dimension increases an alignment tolerance of the scintillator pack-to-pack spacing.

7. The detector assembly of claim 1 wherein each of the plurality of collimator plates is aligned with a centerline of the respective reflector channel.

8. The detector assembly of claim 1 wherein the collimator is composed of at least one of tungsten, molybdenum, and lead.

9. The detector assembly of claim 1 wherein the second thickness of the collimator plates is 100 micrometers.

10. A CT imaging system comprising:
a rotatable gantry having an opening to receive an object to be scanned;
a high frequency electromagnetic energy projection source configured to project a high frequency electromagnetic energy beam toward the object;
a detector assembly positioned on the gantry opposite the high frequency electromagnetic energy projection source, the detector assembly comprising:
a scintillator array comprising a plurality of scintillator cells, and configured to detect high frequency electromagnetic energy attenuated through an object, wherein a reflective material is positioned around each of the plurality of scintillator cells to form reflector channels between each of the plurality of scintillator cells; and
a collimator positioned proximate the scintillator array and configured to filter the high frequency electromagnetic energy attenuated through the object prior to impinging on the scintillator array, the collimator comprising a plurality of collimator plates arranged to form a plurality of channels;
wherein the reflector channels in the scintillator array are formed to have a first thickness and wherein the collimator plates of the collimator are formed to have a second thickness that is equal to or less than the first thickness.

11. The CT imaging system of claim 10 wherein each of the plurality of collimator plates is aligned with a centerline of a respective scintillator cell in at least one dimension.

12. The CT imaging system of claim 11 wherein each of the plurality of collimator plates being aligned with the centerline of a respective scintillator cell in at least one dimension increases an alignment tolerance of the collimator plates to the scintillator array.

13. The CT imaging system of claim 12 wherein, when each of the plurality of collimator plates is aligned with the centerline of a respective scintillator cell in at least one dimension, the alignment tolerance range of the collimator plates to the scintillator array is equal to one half of a pitch of the scintillator cells.

14. The CT imaging system of claim 11 wherein each of the plurality of collimator plates being aligned with the centerline of a respective scintillator cell in at least one dimension reduces an interaction of a collimator plate shadow with an edge of a respective scintillator cell, so as to reduce spectral non-linearity and thermal non-linearity in the scintillator array.

15. The CT imaging system of claim 10 wherein each of the plurality of collimator plates is aligned with a respective reflector channel.

16. The CT imaging system of claim 10 wherein the collimator is composed of at least one of tungsten, molybdenum, and lead.

17. The detector assembly of claim 10 wherein the second thickness of the collimator plates is 100 micrometers.

18. The detector assembly of claim 10 wherein each of the plurality of collimator plates being aligned with the centerline of a respective scintillator cell in at least one dimension increases an alignment tolerance of the scintillator pack to pack spacing.

19. A detector assembly for a CT imaging system, the detector assembly comprising:
a scintillator array comprising a plurality of scintillator cells and configured to detect high frequency electromagnetic energy attenuated through an object, the scintillator array including a reflective material positioned around each of the plurality of scintillator cells to form reflector channels between each of the plurality of scintillator cells; and
a collimator positioned proximate the scintillator array and configured to filter the high frequency electromagnetic energy attenuated through the object prior to impinging on the scintillator array, the collimator comprising a plurality of collimator plates arranged to form a plurality of channels;
wherein each of the plurality of collimator plates is aligned with a centerline of a respective scintillator cell.

20. The detector assembly of claim 19 wherein the reflector channels in the scintillator array are formed to have a first thickness and wherein the collimator plates of the collimator are formed to have a second thickness that is equal to or less than the first thickness.
